(19) United States
(12) Patent Application Publication
(10) Pub. No.: US 2018/0357731 A1
(43) Pub. Date: Dec. 13, 2018

(54) MealBnB (Just Homemade)

(71) Applicant: Mohamed Abd El Aziz Ibrahim, Baltimore, MD (US)

(72) Inventor: Mohamed Abd El Aziz Ibrahim, Baltimore, MD (US)

(21) Appl. No.: 15/619,437

(22) Filed: Jun. 10, 2017

(51) Int. Cl. G06Q 50/12; G06Q 30/06

(52) U.S. Cl. CPC G06Q 50/12; G06Q 30/0601

(57) ABSTRACT

This disclosure relates generally to MealBnB—Just Homemade MealBnB stands for meal bigger and better or meal breakfast and brunch. MealBnB will run based on sharing economy and hospitality worldwide. MealBnB will create jobs by helping people who have the skills of cooking and/or party planning to work from their homes worldwide. MealBnB will be the middleman between party planners at their homes and online customers. MealBnB will save money for its customers by providing healthy affordable homemade parties, events, meetings, food, meals, recipes and/or drinks instead of going to expensive restaurants.

### BACKGROUND

### Field of the Invention

MealBnB is a Website and Mobile Application for marketing and selling Homemade Goods, Products and Services like Homemade Parties, Events, Meetings, Food, Meals, Recipes and/or Drinks for people worldwide.

### Description of the Related Art

The commercial Internet has rapidly evolved in about 10 years into a worldwide medium for electronic commerce among hundreds of millions of users and billions of web sites. However, like all channels of commerce, the use of the Internet depends heavily on the development of efficient means for searching and for advertising to bring interested users to the web sites of vendors of relevant products, services, and/or information. As a result, a new market has been created for buying and selling through mobile applications. However, to Applicant's knowledge, None of these prior art devices has been found to be completely suitable the present invention which is called MealBnB which stands for Meal Bigger and Better or Meal Breakfast and Brunch. MealBnB will run based on Sharing Economy & Hospitality worldwide

### SUMMARY

The following summary is provided to facilitate an understanding of some of the innovative features unique to the present invention and is not intended to be a full description. A full appreciation of the various aspects of the invention can be gained by taking the entire specification, claims, drawings, and abstract as a whole.

In one aspect the present invention is an online platform that will help middle and low class people to work from homes worldwide

MealBnB is a Win-Win Situation

1—MealBnB will create jobs and solve the unemployment problem by helping people who have the skills of cooking and party planning to work from homes worldwide.

2—MealBnB will save money for its customers by providing online healthy affordable Homemade Parties, Events, Meetings, Food, Meals, Recipes and/or Drinks instead of going to expensive restaurants.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows The General idea of MealBnB Which represents the unique combination between Party Planner & Online Customers through ordering online Homemade Party, Food, Meals, Recipes and/or Drinks

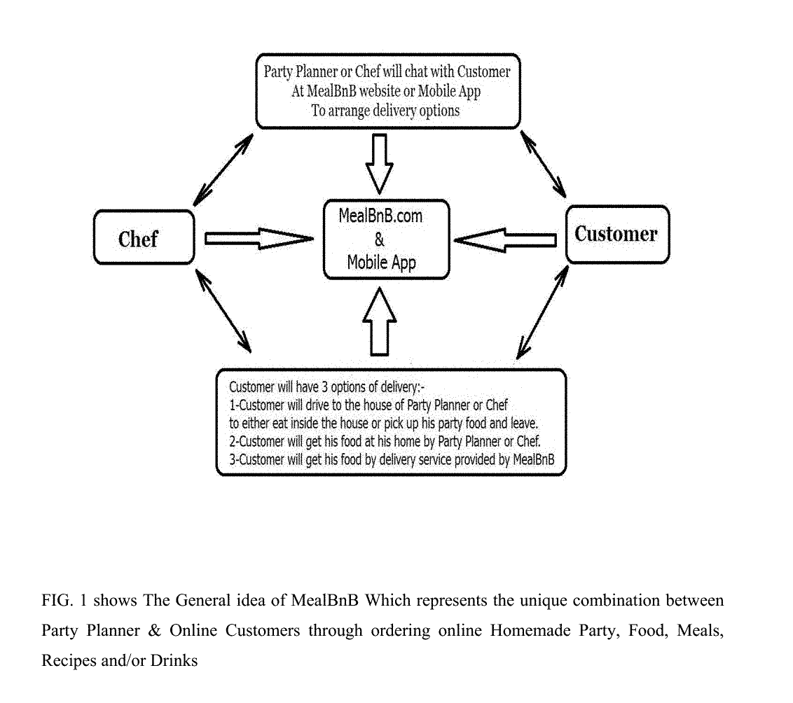

FIG. 2 shows How MealBnB Will Work And how MealBnB will generate revenues through Weekly, Monthly and/or Annual subscriptions.

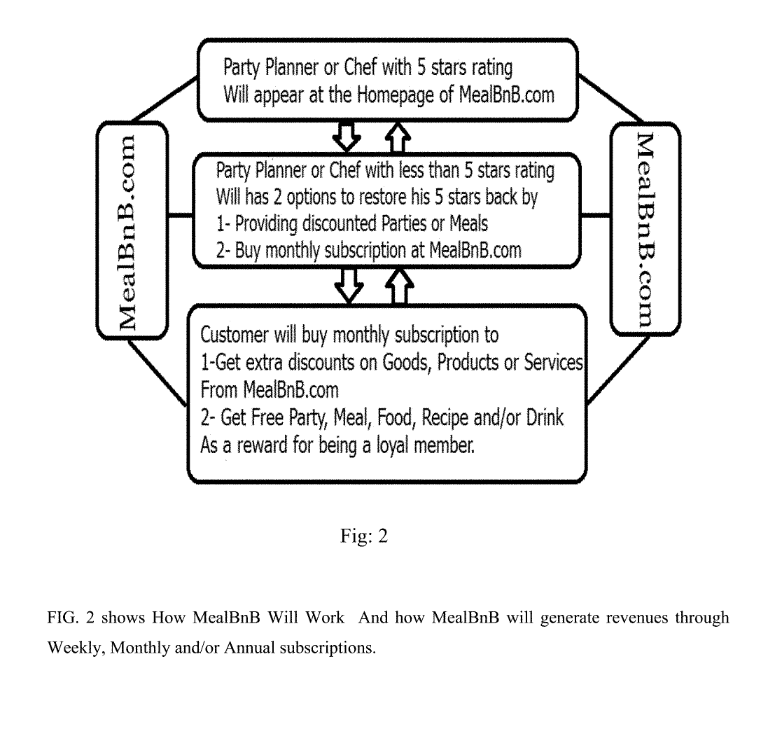

FIG. 3 shows The Main Elements of MealBnB.

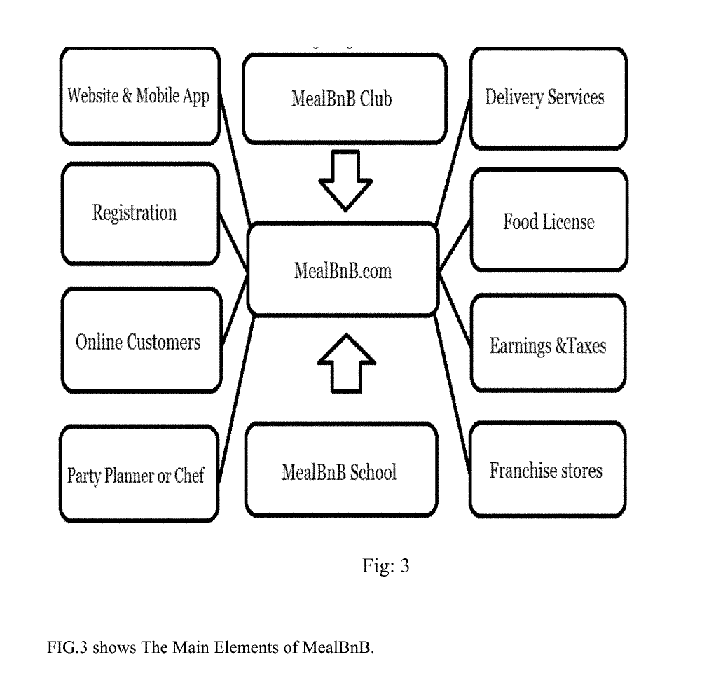

FIG. 4 shows The Logo of the invention MealBnB—Just Homemade in black and white.

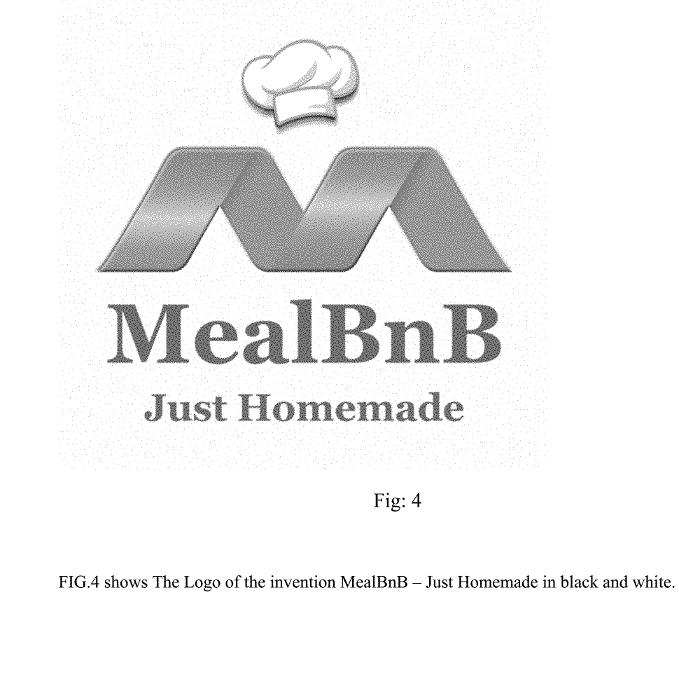

FIG. 5 shows The Colored Logo of the invention MealBnB—Just Homemade.

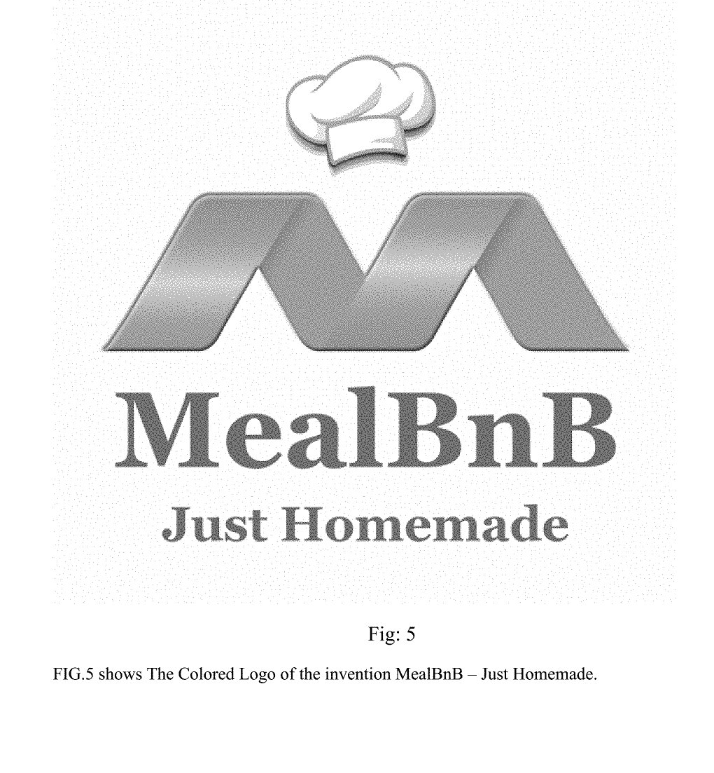

I am the inventor and creator of MealBnB by showing this colored Logo Not claiming any rights for any Trademark.

This colored logo as a way of demonstration how MealBnB will look like in its Natural, Normal and original way at the market.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

There is no system or website looks exactly like the present invention MealBnB.

MealBnB is an attempt to solve The Economic crisis and unemployment problem worldwide for middle and lower class people who are staying home and have the skills of cooking.

MealBnB invention will create jobs and solve the problem of expensive unhealthy food at restaurants.

MealBnB system relies mainly on a Website and/or Mobile Application to solve these problems.

MealBnB business concept will be for marketing and selling online Homemade Goods, Products and/or Services like Homemade Parties, Events, Meetings, Food, Meals, Recipes and/or Drinks worldwide.

The idea of present invention is staying home mom or dad or anyone who has the skills of cooking and party planning can sell his Homemade Party, Meal, Food and/or Drink on MealBnB website and/or Mobile Application of the present invention for a percentage of the price that the Good, Product and/or Service will be sold as a kind of agreement between the Chef and the website since the website will be responsible for the marketing of Homemade Parties, Food, Meals, Recipes and/or Drinks, and the customers will get fresh and healthy homemade food at good and affordable prices in comparison with the market prices.

MealBnB will Solve Great Problems

MealBnB and the unique approach to Solve many problems:—

1—MealBnB will help people who can't cook like students, single people.

2—MealBnB will help people who don't have time for cooking like employed and big families.

3—MealBnB will help people who tired of cooking like old people.

The Main Elements of the Present Invention.

[1] Website and Mobile Application.

[2] Registration For The Website or Mobile Application.

[3] Online Customers.

[4] Party Planner or Chef.

[5] Delivery Services.

[6] Food License of Party Planners or Chefs.

[7] Earnings &Taxes of Party Planner or Chefs

[8] Franchise stores worldwide.

[9] MealBnB Club.

[10] MealBnB School.

[1] Website and Mobile Application.

In MealBnB invention the website and/or mobile application are the main elements of the invention because they are representing the digital real-estate for the invention

3 Types of Accounts Will be Created to be a Member of MealBnB Website:

1st account will be for the customer who is going to buy or place an order for homemade Party. Food, Meal, Recipe and/or Drink online at MealBnB website and/or Mobile App.

2nd account will be for the Party Planner or Chef who is going to work with MealBnB as a partner by Planning Party or Cooking Homemade Food, Meal, Recipe and/or Drink at his home to sell them online at MealBnB.com or the App.

3rd account will be for home delivery option if a third party company will handle the delivery orders.

3 Major Services that the Website Will Run on

1st service by placing online orders at MealBnB website or Mobile App for Homemade Party, Food, Meal, Recipe and/or Drink online between Customer and Party Planner or Chef then deliver Food, Meal, Recipe and/or Drink to the Customer.

2nd service MealBnB website and/or Mobile App will do Catering service and arranging Parties, Wedding, Birthdays, Meetings, Ceremonies and Events between Chefs and Customers.

3rd service MealBnB website and/or Mobile App will be as a Social Media site by providing chatting service among people worldwide to Share, Exchange and Explore their experience about Homemade Parties, Food, Meals, Recipes and/or Drinks worldwide.

How Customer can Find Party Planner or Chef Near Him?

The concept of searching and looking for the nearest Party Planner or Chef on MealBnB website and/or Mobile App will be based on the Zip Code of the Area or The Name of the City, County, Town or Village.

Before placing the order the Customer will enter the 5 digits Zip Code or his full address or the Name of the City, County, Town or Village of his address then MealBnB website or Mobile App will do search and scanning to look for the nearest Party Planner or Chef close to the customer address so he can get fast service for Homemade Party, Food, Meal, Recipe and/or Drink as soon as possible.

MealBnB website and/or Mobile Application are very important elements because they will be the connect between Party Planner, Chef, Customer and the Delivery Boy.

MealBnB Website is Divided into Different Categories:—

1—Global Parties=>The parties will be based on the nationality of the party planner or organizer where you will explore the food and traditions of different nationalities like American party, British party, Italian party . . . etc

2—Cool Parties=>The parties will be based on food name or preferences—like Pasta Party, Seafood Party, Pizza Party . . . etc

3—Social Parties=>The parties will be based on the names of social events—like Anniversaries, Baby Party, Birthday Party, Lunch Party, Dinner Party . . . etc

4—Career Parties=>The parties will be based on jobs names or professions names—like Teacher Party, Engineering Party, Accounting Party . . . etc

5—Holiday Parties=>The parties will be based on the names of Public Holidays and Calendar events—like Mother's day Party, Valentine's day Party, Easter Party, Halloween Party . . . etc

6—Pet Parties=>The parties will be based on the names of pets based on their types—like Dogs Party, Cats Party, Fish Party . . . etc

One of the important element that MealBnB website and/or Mobile App will be organized according to the nationality of the Food, Meal, Recipe and/or Drink, Also the website will provide different categories of Food based on the nationality of the Party Planner or Chef, the following is an example of different categories based on the countries and nationalities:
European=>British, Belgium, Denmark and Scandinavian, French, German, Greek, Irish, Italian, Polish, Portuguese, Romanian, Russian, Spanish, Swiss, Swedish, Turkish, Ukrainian and Bulgarian.
Asian=>Chinese, Emirati, Indian, Iranian, Japanese, Korean, Lebanese, Malaysian, Pakistani, Saudi, Taiwanese, Thai and Vietnamese.
African & Middle Eastern=>Algerian, Egyptian, Moroccan, Tunisian and South African
American.—South American: Brazilian, Jamaican and Mexican.—Canadian.—Australian.—New Zealand

At MealBnB Website and/or Mobile App there are Many Categories of Food, Meals, Recipes and/or Drinks that Will be Provided as the Following:

Appetizers, Alimentation, Baked Goods, Bacon, Barbeque, Basics, Beans and Grains, Breakfast, Brunch, Lunch & Dinner, Beverages, Beef, Beer, Beers, Breads & Butter, Brownies & Bars, Burgers, Cakes, Cheesecakes, Candies, Canning and Preserving, Casseroles, Cereal, Cheese, Chocolate, Condiments, Confectionery, Confections, Confetti, Cooking, Crock Pot and Slow Cooker, Chicken or Poultry, Cookies, Coffee, Cuisine, Cud.

Desserts, Dips, Spreads & Sauces, Diet, Dish & Dishes, Drink, Drinks, Drinkable, Duck Eggs, Ethnic Recipes, Falafel, Fajita, Fast food, Food, Food stuff, Frozen

Yogurt, Fruits, Fruit products, Fish, Fish products, Cooked food, Fried food, Frozen food, Grilled food,

Goodies, Grains, Grilling, Healthy Eating, Healthy food, Healthy meals, Healthy recipe, Healthy salad, Herbs and Spices, Holiday Treats, Hot and Spicy, Hotdog & Sausage, Ice cream, ice cream recipes,

Jellies and Jams, Juice, Juices, junk food, junk recipes

junk meals, Main Dishes, Mexican Meats, Meats products, Milk, Nuts, Nutrient, Nourishment, Nutrition, One Dish Meals, Oatmeal, Pasta, Pastry, Pastry products, Pizza, Pies, Pork, Pets, Porridge, Pabulum, Poultry products, Quick and Easy, Regional Cuisine, Recipes, Rice, Rolls, Salads, Salads recipes, Sandwiches & Wraps, Seafood, Seafood products, Shawarma, Smoothie & Smoothies, Sides, Snacks, Soups & Stews, Stuffing's, Sushi, Sweets, Sweet products, Syrup, Taco, Tea, Vegetarian, Vegetarian products, Weight loss food, Weight loss meals, Weight loss recipes, Weight loss salad, Yogurt & Frozen yogurt, Yogurt smoothie.

MealBnB website and/or Mobile App website will be responsible for marketing and selling Homemade Goods, Products & Services like Homemade Parties, Food, Meals, Recipes and/or Drinks.

MealBnB website and/or Mobile App will work also as a Social Media site by providing chatting service to its members worldwide to share, exchange and explore their experience of Homemade Parties, Food, Meals, Recipes and/or Drinks worldwide.

As a reward for Party Planners or Chefs who are always getting five stars rating they will get free advertising and support from MealBnB by showing their products or services at the main home page of MealBnB website and/or Mobile App to help them make more sales.

[2] Registration for the Website or Mobile Application.

The Registration for All Members at MealBnB.com either Party Planner or Chef or Customer or Delivery Boy they must provide the following information

1—Full name of the member.

2—Date of birth and gender of the member.

3—Current Physical address of the member.

4—Cell phone number of the member because he will receive an Activation Code for his membership at his cell phone.

5—Email address of the member so MealBnB.com will send the new member a confirmation email to his personal email.

6—The member will also has the option to Sign up with his Facebook or Google account or any other social media platform.

7—Americans and USA legal residents who are going to work from their homes as partners with MealBnB website and/or Mobile App need to provide their Social Security Number.

8—Full payment details either for sending money as a Customer who is going to buy Homemade Parties, Food, Meals, Recipes and/or Drinks from MealBnB website or Mobile Application

Or receiving money or payments as a Partner with MealBnB like Party Planner or Chef who is going to sell Homemade Parties, Food, Meals, Recipes and/or Drinks at MealBnB website or Mobile Application. Those payment methods will be like: a—Bank account number for the member. b—Credit Card number either Visa, Master card of the member. c—American Express Card number of the member. d—PayPal email address of the member. All the above information are required to be a member at MealBnB website or Mobile Application for the security and safety of all members including MealBnB website.

[3] Online Customers

MealBnB website and/or Mobile Application will be the middleman between MealBnB Partners like Party Planners or Chefs who are going to work from Homes and Online Customers.

At MealBnB invention, the customer can place an order for any type of Homemade Party, Food, Meal, Recipe and/or Drink.

Customer will have Three options for order delivery:—

1—Customer will drive his car to the house of Party Planner or Chef to either eat inside the house or pick up his party food and leave.

2—Customer will get his food at his home which will be delivered by The Party Planner or Chef based by previous arrangement between them at MealBnB website and/or Mobile Application.

3—Customer will get his food by delivery service provided by MealBnB or by a third party company which will work for MealBnB for delivery service.

[4] Party Planner or Chef

For the Party Planner or Chef who will work as a partner with MealBnB

There will be two options with a previous agreement with MealBnB.

1st option is MealBnB will deduct a percentage from the total order price of the Homemade Good, Product or Service that will be sold on MealBnB website or Mobile Application plus taxes fees.

2nd option is MealBnB will charge Party Planner or Chef a flat Weekly, Monthly or Annual subscription as a membership fees for working with MealBnB website and/or Mobile Application plus taxes fees.

Rating & Evaluation of Party Planner or Chef

1—Chef or Party Planner with 5 stars rating will appear at the Homepage of MealBnB website and/or Mobile Application.

Chef or Party Planner who has less than 5 stars rating will have 2 options to restore his 5 stars back by:

a—Buying Weekly or Monthly or Annual subscription at MealBnB.

b—Providing discounted Parties or Meals for a specific time at MealBnB.com so he can earn a website credit.

2—There will be 2 kinds of membership at MealBnB website and/or Mobile App

a—Chef or Party organizer will pay Weekly, Monthly or Annual subscription to restore his 5 stars rating again or to earn a higher percentage of cash.

b—Customer will pay Weekly, Monthly or Annual subscription to get discounted Parties or Meals.

[5] Delivery Services

[1] 1^{st} stage of delivery service at MealBnB is Party Planner or Chef can have the option of doing the delivery to his Customers for extra profit.

[2] 2^{nd} stage of delivery service MealBnB will recruit or sign a contract with another company to handle the delivery for MealBnB Customers.

[3] 3^{rd} stage or final stage of delivery service when MealBnB business grows at this stage MealBnB will have its own delivery teams who are going to handle all deliveries from Party Planners or Chefs houses to Customers houses.

As the business grows there will be a delivery department which is going to take care of the quality of the delivery service and how fast it is.

For each city, county, town or village there will be a delivery team wearing the uniform with the logo of the company to serve their area in a good and efficient way. The delivery boy is going to work for the website.

[6] Food License of Party Planners or Chefs

For each Party Planner or Chef who is going to work with MealBnB website and/or Mobile Application as a partner he has to get a Food License from the Health Department of the state of his residence or his Government for global partners worldwide.

So each Party Planner or Chef will be responsible for the quality and safety of the Party, Food, Meals, Recipes and/or Drinks that he will cook or provide to The Customers at MealBnB website and/or Mobile Application.

[7] Earnings &Taxes of Party Planner or Chefs How Party Planners or Chefs will collect their Earnings & Pay their taxes
MealBnB partners will get their earnings on a weekly or monthly basis in form of checks, PayPal, wire transfer, western union or any other payment method.
Americans or legal residents of The USA who will work with MealBnB website and/or Mobile Application as Partners have to pay their own governmental taxes by filing their own W9 forms and/or other taxes forms by themselves.
So each Party Planner or Chef will be responsible to pay his own taxes for the money he made or earned during the previous year
MealBnB partners worldwide are required to pay taxes on their earning with MealBnB website and/or Mobile App to their own governments

[8] Franchise Stores Worldwide

MealBnB business model will be based on Sharing Economy & Hospitality worldwide,

And the expected market share for MealBnB will be great because each house worldwide has a kitchen.

MealBnB doesn't require renting stores nor hiring employees to run the business since the whole business will be conducted from homes.

This will eliminate the need for rental premises and reduce operational costs thereby maximize shareholders' capital.

MealBnB is a great business opportunity in a fast growing market worldwide with minimal competition rates that will provide amazing returns on the global scale.

The idea of MealBnB website and/or Mobile App will be developed as a franchise by having physical stores distributed worldwide

The present invention will not be just a website and/or Mobile Application only.

But I will develop the same idea of MealBnB website and/or Mobile Application into a franchise.

By establishing physical stores to reach and serve more customers worldwide

And to help the humanity by providing healthy Homemade Food, Meals, Recipes and/or Drinks worldwide at affordable prices.

[9] MealBnB Club

With The Club membership MealBnB will have a New meaning

MealBnB will be Bigger in its meaning and Better in its Value.

MealBnB will stands for Meal Bed and Breakfast

MealBnB Club membership is going to help travelers by providing an extra service for sleeping or spending nights at the houses of other MealBnB members like Party Planners, Chefs and other regular members of MealBnB who wants to earn extra income from their homes by hosting other MealBnB members to spend nights at their homes for extra profit.

MealBnB Club Will Require Weekly, Monthly or Annual Subscription

MealBnB Club will provide special and extra services for its loyal members

There will be Two kinds of MealBnB Club members

[1] 1st Kind of MealBnB Club member is Party Planner or Chef who will work from home as MealBnB Partner.

Party Planner or Chef as Club member will enjoy with the following services

1—Party Planner or Chef will earn an extra percentage on his sales or more commissions on his sales from MealBnB website and/or Mobile App.

2—Party Planner or Chef as Club member can earn extra money from home by hosting other MealBnB members to sleep and spend one night or more at his own house.

3—Party Planner or Chef his Goods, Products or Services will appear on the 1st page or home page of MealBnB website and/or Mobile App.

4—Party Planner or Chef with low rating less than 5 stars from customers, MealBnB will improve his rating back to 5 stars.

5—If Party Planner or Chef will plan for late party through MealBnB and he wanted to host his guest to sleep or spend the night at his house for an extra profit or money the Party Planner or Chef will have this extra option.

6—Party Planner or Chef as club member, MealBnB will help him with the delivery to his customers for lower delivery cost.

7—Party Planner or Chef if he wanted to buy any Good, Product or Service from MealBnB as a Customer, He will get discounted prices and low price rate.

8—If The Party Planner or Chef as club member will travel away from his home and he wanted to sleep and spend one night or more at any other MealBnB members as a Customer, He will get discounted price and low price rate.

[2] 2nd Kind of MealBnB Club member is MealBnB Customer.

MealBnB Customer who will buy Goods, Products or Services from MealBnB website and/or Mobile Application.

Loyal Customer as a MealBnB Club member will enjoy the following services:

1—Loyal Customer will save money by getting extra discounts or low prices when he buys Goods, Products or Services from MealBnB website and/or Mobile App.

2—If Loyal Customer is attending late party he can have the option of sleeping at the house of his host for a low or cheap price based on mutual agreement between them.

3—Loyal Customer as club member will get Free Party, Meal, Food, Recipe and/or Drink as a reward and appreciation for being loyal member.

4—If the Loyal Customer is traveling away from his home and he wanted to sleep and spend one night or more at any other MealBnB members he will enjoy this option for a cheap or low price per night.

5—Loyal Customer as Club member he can earn money from his home by hosting other MealBnB members to sleep and spend one night or more at his home for a good profit.

[10] MealBnB School

The idea behind MealBnB School is to help regular people to have new skills of Party Planning and/or Cooking which will enable them to find jobs by working with MealBnB as Partners

1—Teachers at MealBnB School will be Party Planners and/or Chefs.

2—Students at MealBnB School will be regular MealBnB Members or Customers.

3—The Student of MealBnB School will pay the price of his classes to MealBnB website and/or Mobile App and MealBnB will split the profit with its Teachers.

At MealBnB School the skilled Party Planner or Chef will join MealBnB School as a teacher and will give Classes of Planning parties and/or Cooking to other MealBnB regular Members or Customers at his own home.

Party Planner and/or Chef will teach regular Members or Customers the best cooking skills to help them to work as new partners to MealBnB website and/or Mobile App.

1) Exclusive right for Marketing and/or Selling Homemade Goods, Products and/or Services in form of Parties, Food, Meals, Recipes, Drinks from local Homes and/or Houses to local people who live in the same City, Community, Country, Town, Society, and Village worldwide by using the internet through a Website and/or Mobile Application.

2) Exclusive right of using the expression or title—Just Homemade.
